(19) United States
(12) Patent Application Publication
(10) Pub. No.: US 2013/0067835 A1
(43) Pub. Date: Mar. 21, 2013

(54) DECORATIVE FRAME BODY

(71) Applicant: Tser Wen CHOU, Taipei City (TW)

(72) Inventor: Tser Wen CHOU, Taipei City (TW)

(21) Appl. No.: 13/239,150

(22) Filed: Sep. 21, 2011

(51) Int. Cl. E06B 5/00; E06B 9/38

(52) U.S. Cl. 52/173.1; 52/208

(57) ABSTRACT

A decorative frame body includes at least four decorative boards and several fixing seats. Each decorative board has a sunshade section and an engagement channel formed on the bottom face of the decorative board. Each fixing seat has a fixing base and latch sections extending from the fixing base in adaptation to the engagement channel. The fixing seats are fixed on the wall face beside the window frame. The latch sections of the fixing seats are latched in the engagement channel to connect the decorative boards with the fixing seats as a decorative periphery of the window. The sunshade sections of the decorative boards serve to block the gaps between the blind slats and the window frame and prevent the sunlight from going into the room from the gap.

### BACKGROUND OF THE INVENTION

1. Field of the Invention

The present invention relates generally to a decorative frame body for shading sunlight and achieving a decoration effect.

2. Description of the Related Art

A conventional blind is usually installed on an inner side of a window for interrupting external sunlight from being projected into a room so as to lower the temperature in the room and avoid stimulation of eyes. In order to smoothly lift and lower the blind slats, the width of the blind slats is generally smaller than the width of the window. Under such circumstance, the blind can hardly cover the entire range of the window. As a result, the sunlight will still go into the room through the gap between the blind slats and the window frame.

There is another type of blind having decorative plates affixed to the window frame for shading sunlight. However, the decorative plates are integrally connected with the window frame. When taking off or replacing the decorative plates, it is necessary to remove the entire set of decorative plates. Therefore, it is quite inconvenient to install/uninstall such decorative plates and the cost for such decorative plates is high.

### SUMMARY OF THE INVENTION

It is therefore a primary object of the present invention to provide a decorative frame body capable of fully shading sunlight and providing a beautifying/decorating effect. The sunshade sections extending from the decorative boards of the decorative frame body serve to block the gaps between the blind slats and the window frame. Accordingly, the problem existing in the conventional blind that the sunlight cannot be fully shaded can be solved. The decorative boards of the decorative frame body is conveniently installable and uninstallable. Moreover, the decorative frame body is able to provide a beautifying/decorating effect for the blind and the window frame.

To achieve the above and other objects, the decorative frame body of the present invention includes at least four decorative boards and several fixing seats fixed on the wall face beside the window frame. Each decorative board has a waved decorative face formed on a top section of the decorative board, an engagement channel formed on a bottom section of the decorative board and a sunshade section directly extending from the waved decorative face. The engagement channel has an inner channel wall face, an outer channel wall face and a top channel wall face. Each fixing seat has a fixing base and latch sections extending from two sides of the fixing base. The latch sections of the fixing seat can be latched in the engagement channel, whereby the decorative board can be detachably connected with the fixing seats.

The sunshade sections of the decorative boards serve to block the gaps between the blind slats with insufficient length and the periphery of the window frame and interrupt the sunlight from going into the room from the gap.

The decorative frame body of the present invention is also applicable to the corners between the wall faces and the floor and ceiling for decoration. The fixing seats are affixed to the corners between the wall faces and the floor and ceiling and then the decorative boards with the waved decorative faces are directly latched and connected with the fixing seats to achieve a decorating/beautifying effect.

The present invention can be best understood through the following description and accompanying drawings, wherein:

### BRIEF DESCRIPTION OF THE DRAWINGS

FIG. 1 is a perspective exploded view of a first embodiment of the present invention;

FIG. 2 is a perspective view of the fixing seat of the present invention;

FIG. 3 is a sectional view showing that the fixing seat is elastically latched with the decorative board;

FIG. 4 is a perspective exploded view of the first embodiment of the present invention, showing the installation thereof;

FIG. 5 is a sectional view of the first embodiment of the present invention, showing the installation thereof;

FIG. 6 is a sectional view according to FIG. 5, showing that the decorative board is pressed against the fixing seat;

FIG. 7 is a sectional view according to FIG. 6, showing that the leaf springs of the fixing seat are inward pressed toward each other;

FIG. 8 is a sectional view according to FIG. 7, showing that the leaf springs of the fixing seat are latched with the decorative board;

FIG. 9 is a perspective view showing that the installation of the decorative frame body of the present invention is completed;

FIG. 10 is a sectional view showing the path of the sunlight;

FIG. 11 is a sectional view showing that the sunlight is interrupted by the present invention;

FIG. 12 is a perspective exploded view of a second embodiment of the present invention;

FIG. 13 is a perspective exploded view of a third embodiment of the present invention; and

FIG. 14 is a sectional view showing that the decorative frame body of the present invention is applied to the corners between the wall faces and the floor and ceiling.

### DETAILED DESCRIPTION OF THE PREFERRED EMBODIMENTS

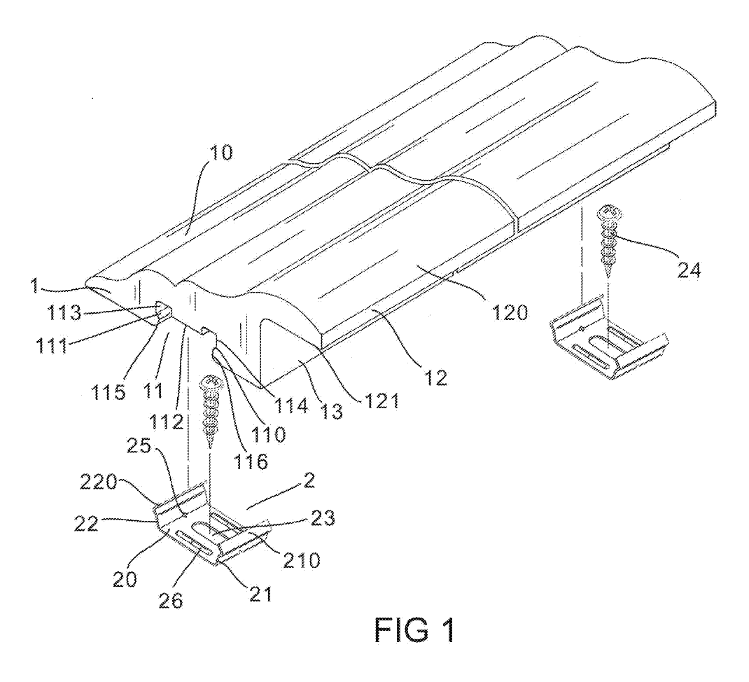

Please refer to FIGS. 1 to 4. According to a first preferred embodiment, the decorative frame body of the present invention includes four decorative boards 1 and several fixing seats 2. Referring to FIG. 1, each decorative board 1 has a waved decorative face 10 formed on a top section of the decorative board 1, an engagement channel 11 formed on a bottom section of the decorative board 1 and a sunshade section 12 directly extending from the waved decorative face 10. The sunshade section 12 has an arcuate face 120 directly extending from the waved decorative face 10 and a plane face 121 positioned on a bottom face of the sunshade section 12. The plane face 121 is perpendicularly connected with the main body of the decorative board 1 to define aright angle space 13. The engagement channel 11 has an inner channel wall face 110, an outer channel wall face 111 and a top channel wall face 112. The inner sides of the inner and outer channel wall faces 110, 111 are formed with recessed faces 113, 114. The outer sides of the inner and outer channel wall faces 110, 111 are formed with arcuate sections 115, 116 for latching with the fixing seats 2.

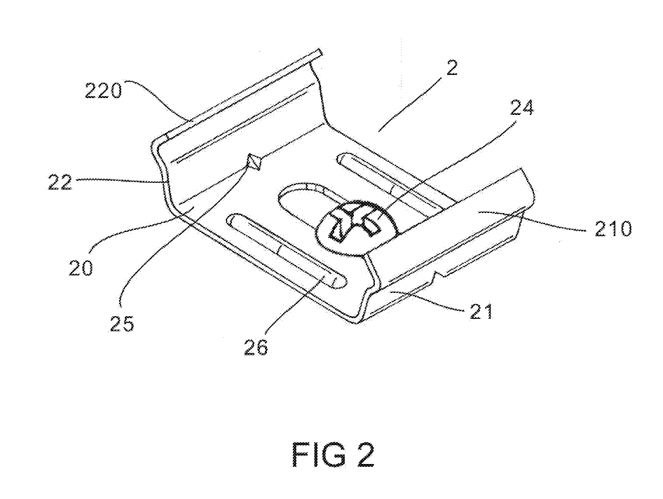

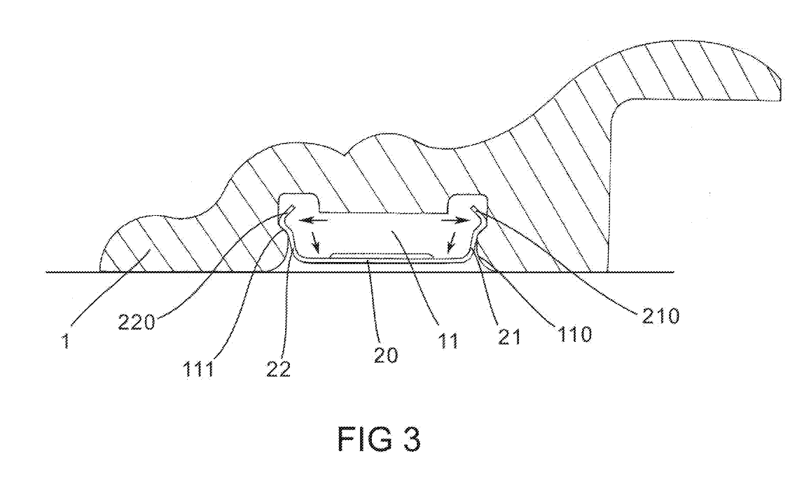

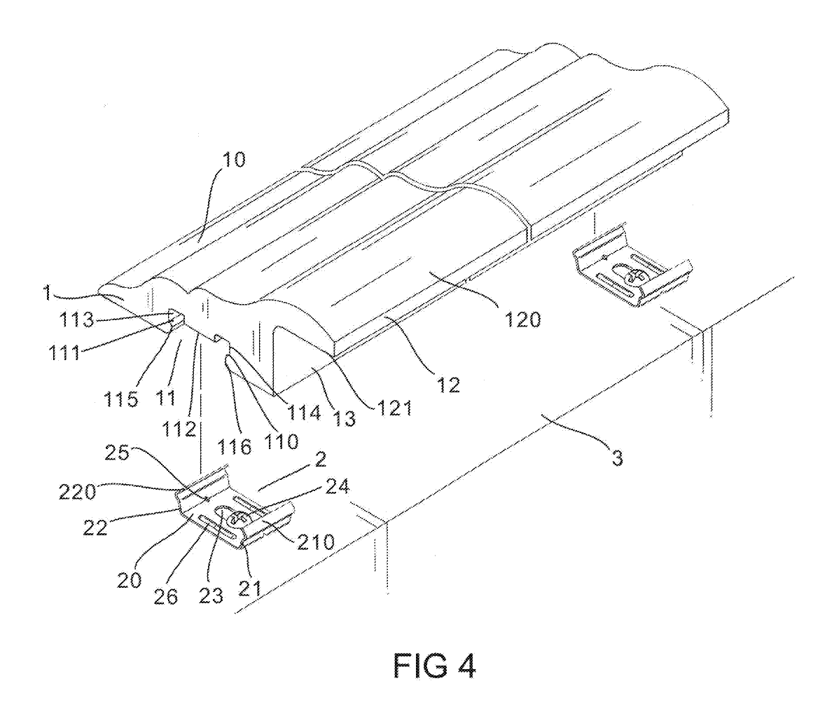

Referring to FIGS. 1 and 2, each fixing seat 2 has a fixing base 20 and two leaf springs 21, 22 upward extending from two sides of the fixing base 20 respectively. The fixing base 20 can be fixed on a wall face 3 beside a window frame by means of a fixing screw 24. The leaf springs 21, 22 have a height smaller than that of the inner and outer channel wall faces 110, 111 (as shown in FIG. 3). After the fixing seat 2 is mounted in the engagement channel 11, the leaf springs 21, 22 provide elastic fixing force. Two latch sections 210, 220 integrally obliquely extend from the top ends of the leaf springs 21, 22. Reinforcement structures 25 are formed in a bending line around which the leaf springs 21, 22 are bent relative to the fixing base 20. The fixing base 20 is formed with a slot 23 and two reinforcement ribs 26. The fixing screw 24 is passed through the slot 23 to affix the fixing base 20 to the wall face 3 beside the window frame (as shown in FIGS. 1 and 4).

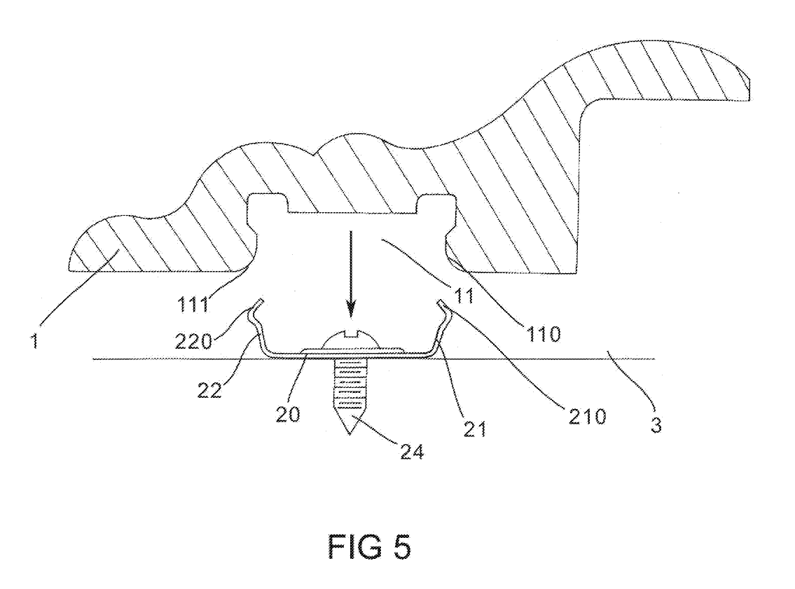

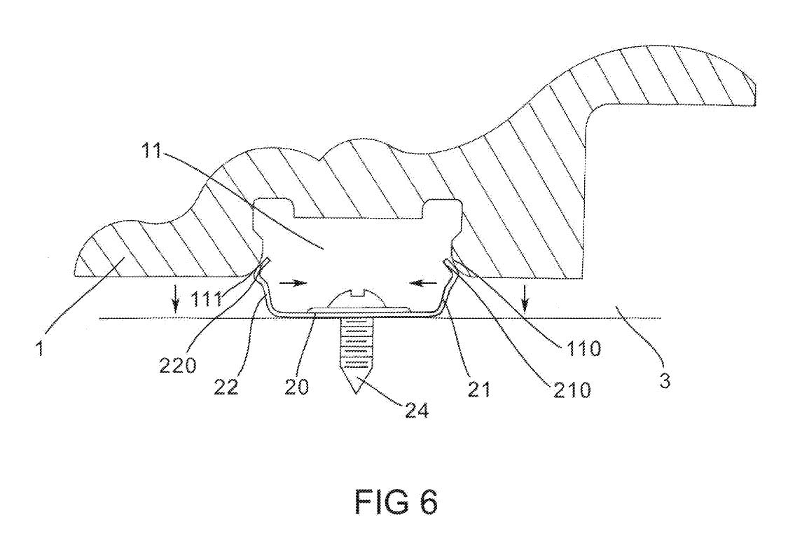

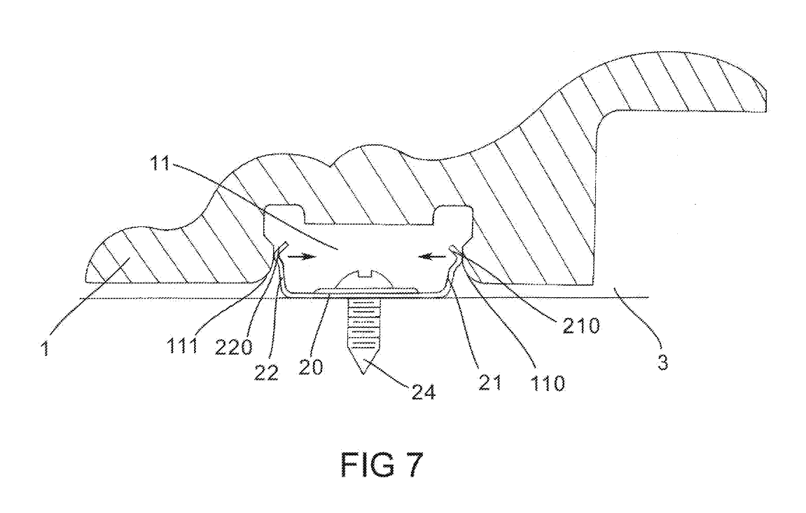

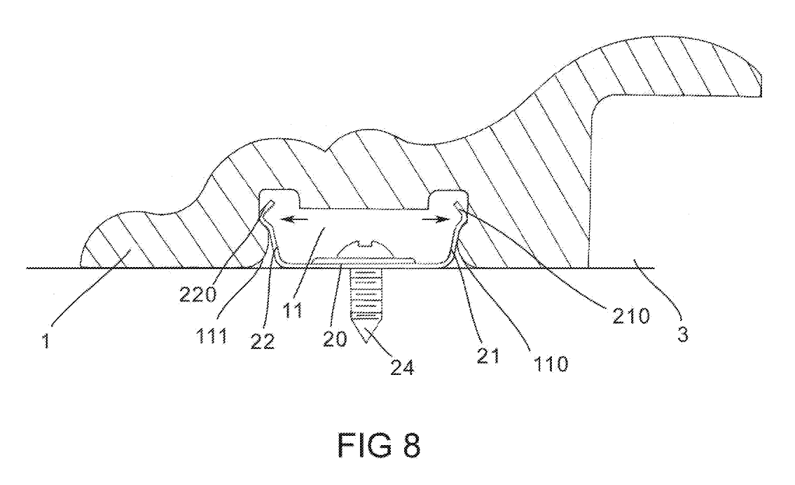

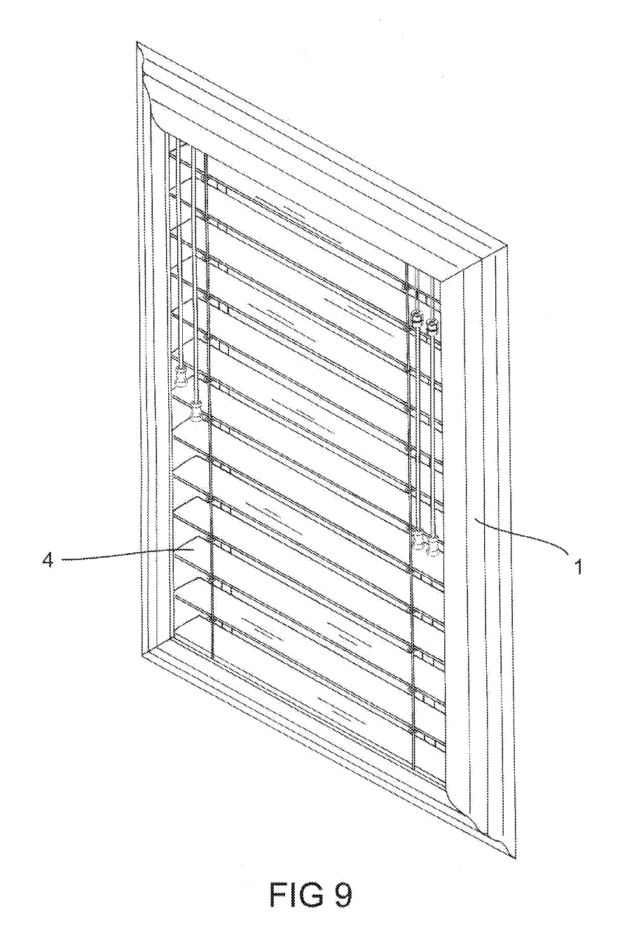

Referring to FIGS. 5 to 8, when installed, a necessary number of fixing seats 2 are affixed to the wall face 3 beside the window frame. Then the engagement channel 11 of the bottom section of the decorative board 1 is aimed at the fixing seats 2 to directly latch the decorative board 1 with the fixing seats 2. At this time, the latch sections 210, 220 of the fixing seats 2 are pushed by the inner and outer channel wall faces 110, 111, whereby the leaf springs 21, 22 are inward pressed toward each other (as shown in FIGS. 6 and 7). Then, the leaf springs 21, 22 elastically restore to make the latch sections 210, 220 snugly attach to the recessed faces 113, 114 of the inner and outer channel wall faces 110, 111. Under such circumstance, the decorative board 1 is detachably connected with the fixing seats 2 as shown in FIG. 8. The four decorative boards 1 are sequentially affixed to the wall face along the periphery 40 of the window frame (as shown in FIG. 9). In this case, the sunshade sections 12 are right positioned in front of the gaps 41 between the blind slats 4 and the periphery 40 of the window frame. The right angle spaces 13 defined under the sunshade sections 12 provide rotational spaces for the blind slats 4.

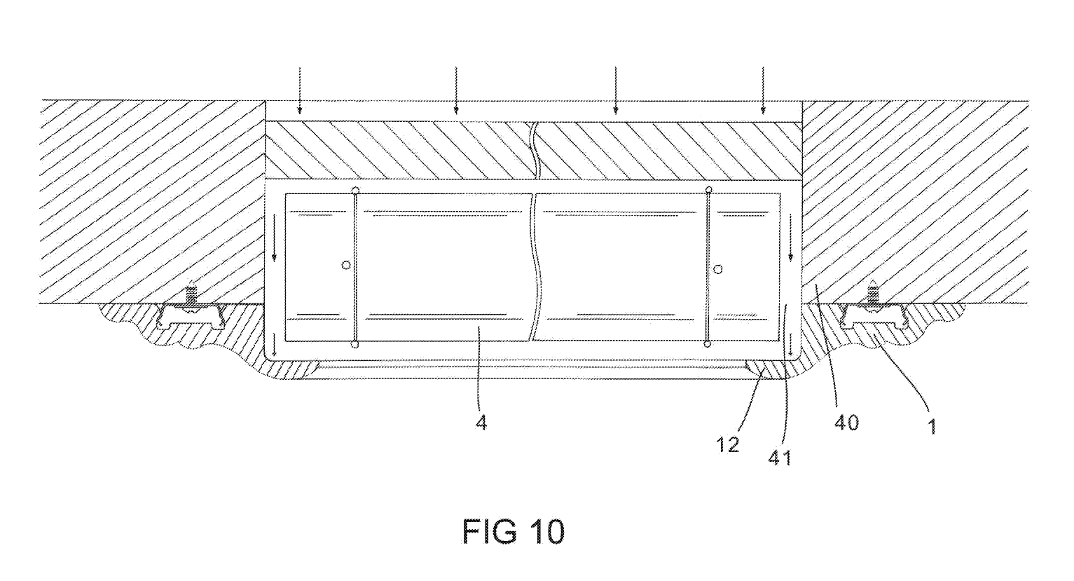

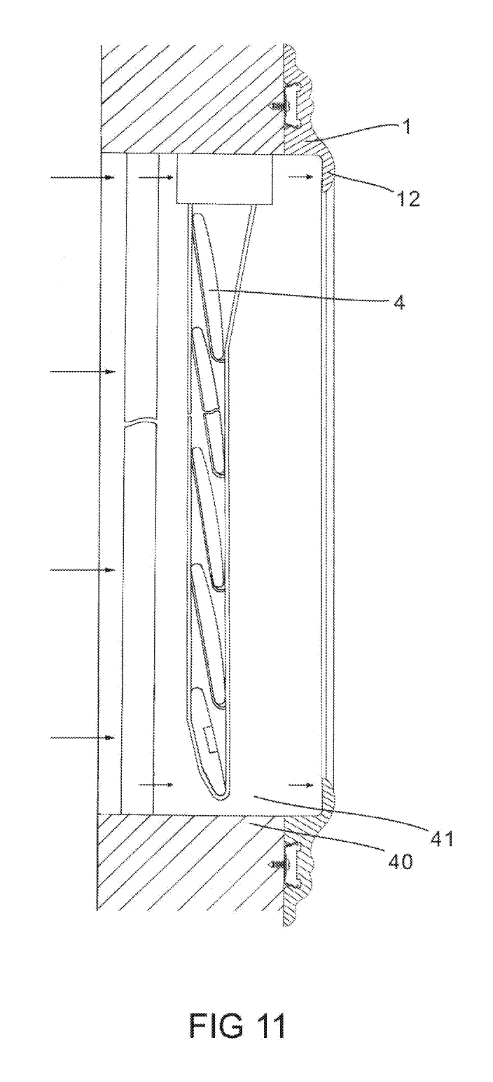

When the blind slats 4 are opened, the sunlight is projected from outer side into the room. When the blind slats 4 are closed, the room is shaded from the sunlight. Moreover, the sunlight passing through the gaps 41 between the blind slats 4 and the periphery 40 of the window frame is interrupted by the sunshade sections 12. Accordingly, a full sun shading effect is achieved (as shown in FIGS. 10 and 11).

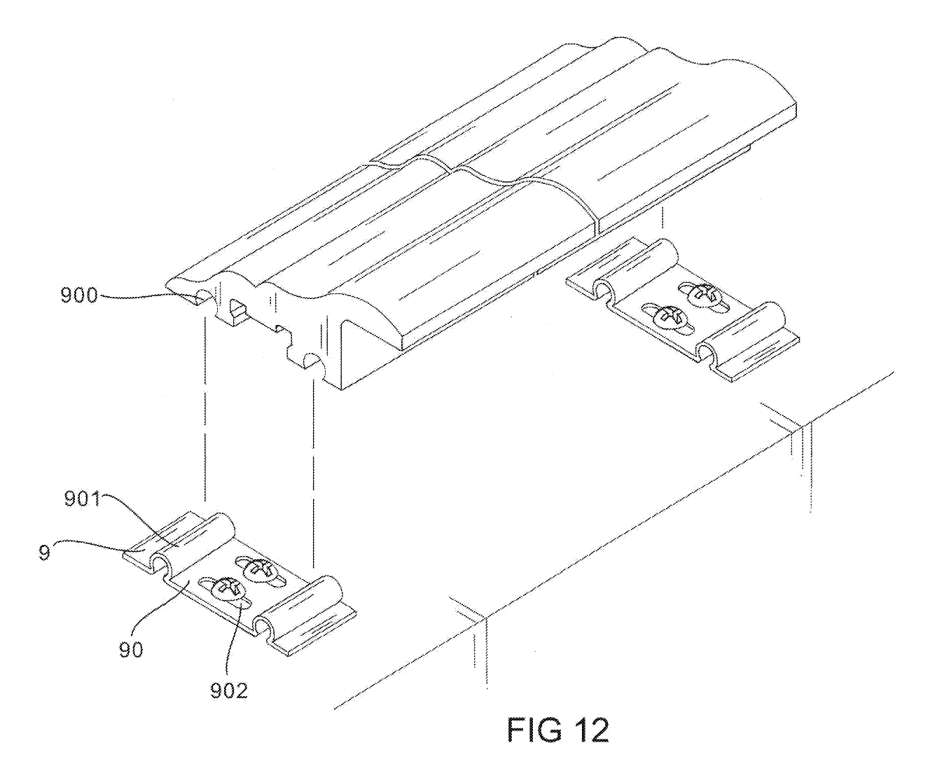

FIG. 12 shows another preferred embodiment of the decorative frame body of the present invention. In this embodiment, the fixing seat 9 has a fixing base 90 and two domed latch sections 901 extending from two sides of the fixing base 90. The fixing base 90 can be fixed on a wall face beside a window frame by means of fixing screws. The domed latch sections 901 can be latched in the engagement channels 900 formed on the bottom face of the decorative board 1. The fixing base 90 is formed with two slots 902. When the domed latch sections 901 are latched in the engagement channels 900, the decorative board 1 is detachably connected with the fixing seat 9.

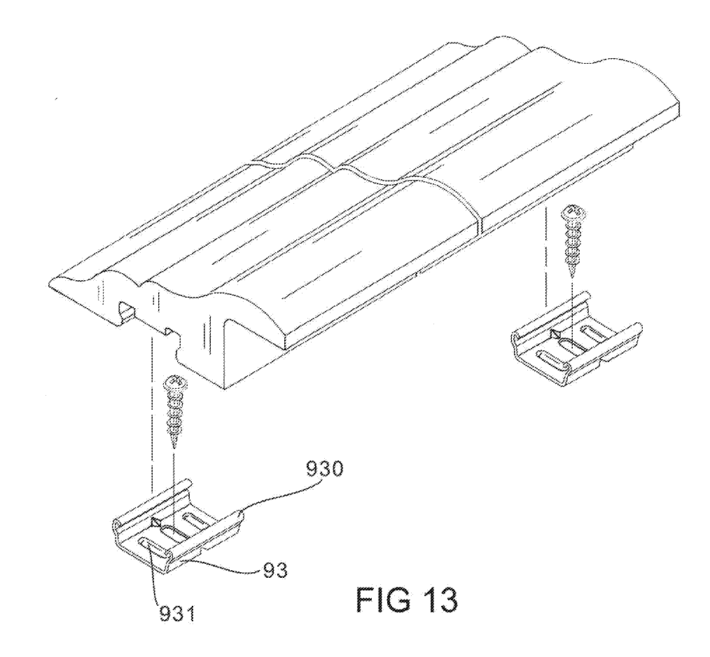

FIG. 13 shows still another preferred embodiment of the decorative frame body of the present invention. In this embodiment, the leaf springs 93 upward obliquely extend from two sides of the fixing base. Two latch sections 930 extend from the top ends of the leaf springs 93 in an arcuate form. The fixing base is also formed with reinforcement ribs 931 for increasing the structural strength of the fixing seat.

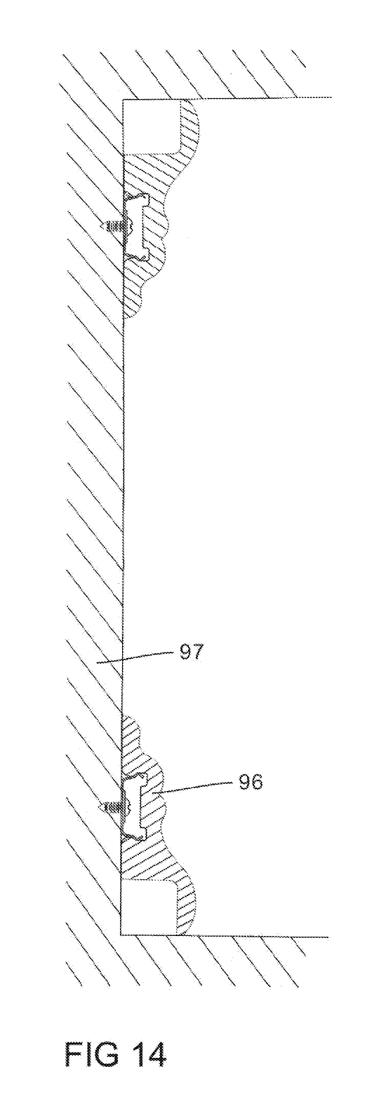

FIG. 14 shows that the decorative frame body of the present invention is applied to the corners between the wall faces and the floor and ceiling. The fixing seats are affixed to the corners 97 between the wall faces and the floor and ceiling and the decorative boards 96 are connected with the fixing seats to achieve a decoration effect.

The above embodiments are only used to illustrate the present invention, not intended to limit the scope thereof. Many modifications of the above embodiments can be made without departing from the spirit of the present invention.

1. A decorative frame body for decorating a window frame and wall face, the decorative frame body comprising:
four decorative boards each having plane bottom face;
a waved decorative face disposed on a top section of the decorative board;
an engagement channel formed on the bottom face of the decorative board, the engagement channel having an inner channel wall face, an outer channel wall face and a top channel wall face;
a sunshade section directly extending from the waved decorative face, the sunshade section having an arcuate top face and a plane bottom face; and
a fixing seat latched in the engagement channel, the fixing seat having a fixing base and leaf springs integrally extending from two sides of the fixing base, the fixing base being fixable on a wall face beside a window frame by means of a screw, two latch sections integrally extending from top ends of the leaf springs, the latch sections being latchable with the inner and outer channel wall faces of the engagement channel, the fixing base being formed with a slot, whereby the screw is passed through the slot to affix the fixing base to the wall face beside the window frame and the decorative board can be connected with the fixing seat.

2. The decorative frame body as claimed in claim 1, wherein the leaf springs are inclined from the fixing base by an inclination larger than 90 degrees.

3. The decorative frame body as claimed in claim 1, wherein the latch sections of the leaf springs have a configuration adapted to that of the inner and outer channel wall faces of the engagement channel.

4. The decorative frame body as claimed in claim 1, wherein the latch sections on two sides of the fixing seat have the form of oblique boards.

5. The decorative frame body as claimed in claim 1, wherein the latch sections on two sides of the fixing seat have the form of arcuate bodies.

6. The decorative frame body as claimed in claim 1, wherein reinforcement structures are formed in a bending line around which the leaf springs are bent relative to the fixing base of the fixing seat.

7. The decorative frame body as claimed in claim 1, wherein the fixing base of the fixing seat is formed with several reinforcement ribs.

8. (canceled)
